(19) United States
(12) Patent Application Publication
(10) Pub. No.: US 2005/0040963 A1
(43) Pub. Date: Feb. 24, 2005

(54) Functional indicating meter for cooperating with sensing element

(76) Inventor: Jui-Yang Lo, Junghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/642,815

(22) Filed: Aug. 19, 2003

(51) Int. Cl. G08B 5/22

(52) U.S. Cl. 340/815.45; 340/438

(57) ABSTRACT

A functional indicating meter for cooperating with sensing elements is disclosed. The meter includes a selecting switch, a signal-controlling module, a signal-receiving module, a signal-judging module, a displaying/alarming module and a panel-indicating module. The sensing signals from several similar sensing elements at different locations are simultaneously inputted into the signal-receiving module. Then, through switching of the selecting switch and the signal-controlling module for selecting the sensing signal wanted to receive, this sensing signal will simultaneously be outputted to the panel-indicating module and the signal-judging module. The panel-indicting module will directly display the value of this sensing signal, and simultaneously the signal-judging module will process a value comparison for abnormal ones. If it reveals abnormal, it can notice the user through the displaying/alarming module. The functional indicating meter can be switched to display the value of each sensing element located everywhere so as to achieve purposes of displaying and alarming.

### BACKGROUND OF THE INVENTION

1. Field of the Invention

The present invention relates to a functional indicating meter for cooperating with sensing elements, and more particularly to a functional indicating meter that can be switched to display the value of each sensing element located everywhere so as to achieve the purposes of displaying and alarming.

2. Description of the Prior Art

Please refer to FIG. 1 that is a practicing schematic view showing the instrument panel which cooperates with the oil boxes. As shown in FIG. 1, the instrument panel 1 is set on a boat. Because there will be several oil boxes on the boat for long-distance traveling and in order to make the user to understand the oil reserves, all the sensing elements set inside the oil boxes are connected to the instrument panel 1. After the power switch 1 is opened, the power indicator 12 will become to shine. Moreover, the user can refer to an indicating site map 13, located at the upper portion of FIG. 1, and turn a selecting switch 14 to the number which is wanted to know, so that the oil reserve of the indicated oil box can be displayed through a needle meter 15. When the user needs to know the oil reserve of another oil box, the user has to adjust the select switch 14 first and then close the power switch 11 and reopen it again so that the oil reserve of this oil box can be displayed.

The main disadvantages of this conventional instrument panel for cooperating with the oil boxes are:
1. Because the power switch has to be closed first and reopened again in order to successfully switch when the user switches the display of the oil box each time, the operating procedures are too complicated.
2. It has only one single displaying function, and thus it can not warn the user.
3. It has to be inset the needle meter, power switch, power indicator, selecting switch and indicating site map, and thus the volume thereof will become too larger so as to inconvenience the user as installing.
4. It is localized to use in measuring the oil amount of boat, so that if it is used in different field or measuring different sensing sources, it will need to be redesigned.

Thus, it can be seen, the prior art described above still has some defects, is not a good design, however, and is urgently to be improved.

Because of the technical defects of described above, the applicant keeps on carving unflaggingly to develop a functional indicating meter for cooperating with sensing elements through wholehearted experience and research.

### SUMMARY OF THE INVENTION

An object of the present invention is to provide a functional indicating meter for cooperating with sensing elements that can be switched to display the value of each sensing element located everywhere so as to achieve the purposes of displaying and alarming.

Another object of the present invention is to provide a functional indicating meter for cooperating with various sensing elements of measuring oil amount, temperature, liquid level and oil pressure etc.

Another further object of the present invention is to provide a functional indicating meter can cooperates with sensing elements and also be used in all kinds of traffic transportations, e.g. airplanes, boats and vehicles etc.

For achieving the purposes described above, the functional indicating meter for cooperating with sensing elements according to the present invention includes a selecting switch, a signal-controlling module, a signal-receiving module, a signal-judging module, a displaying/alarming module and a panel-indicating module. The sensing signals from several similar sensing elements at different locations are simultaneously inputted into the signal-receiving module, and then, through switching of the selecting switch and the signal-controlling module for selecting the sensing signal wanted to receive, this received sensing signal will simultaneously be outputted to the panel-indicating module and the signal-judging module. The panel-indicting module will directly display the value of this received sensing signal, and simultaneously the signal-judging module will process a value comparison for abnormal ones; if it reveals abnormal, it can notice the user through the displaying/alarming module.

### BRIEF DESCRIPTION OF THE DRAWINGS

The drawings disclose an illustrative embodiment of the present invention which serves to exemplify the various advantages and objects hereof, and are as follows:

FIG. 1 is a practicing schematic view showing an instrument panel for cooperating with an oil box in the prior art;

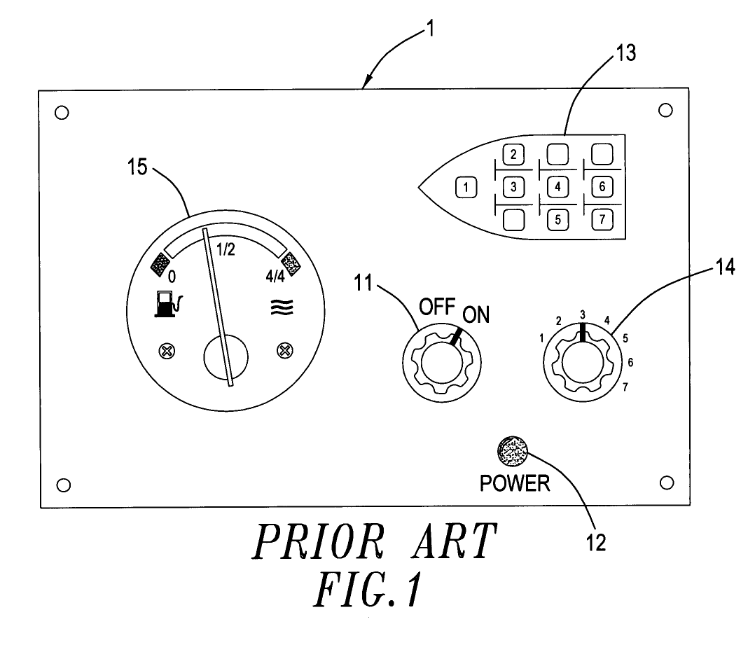

FIG. 2 is a block diagram showing a functional indicating meter for cooperating with sensing elements according to the present invention;

FIGS. 3(a)˜3(d) are practicing schematic views of the functional indicating meter for cooperating with sensing elements in a preferable embodiment according to the present invention; and

FIGS. 4(a) and 4(b) are practicing schematic views of the functional indicating meter for cooperating with sensing elements in another preferable embodiment according to the present invention.

### DETAILED DESCRIPTION OF THE PREFERRED EMBODIMENT

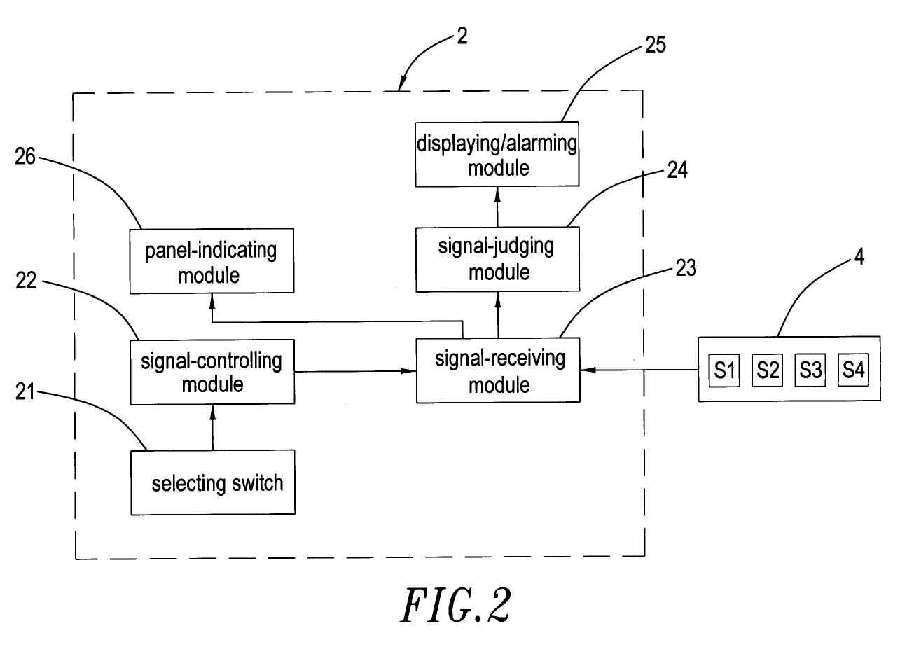

Please refer to FIG. 2 which illustrates a block diagram showing a functional indicating meter for cooperating with sensing elements according to the present invention. As shown in FIG. 2, the functional indicating meter for cooperating with sensing elements according to the present invention includes:
a selecting switch 21 for inputting a switching signal into a signal controlling module;
a signal-controlling module 22 for outputting a control signal to a signal receiving module 23 so as to control a sensing signal outputted by the signal receiving module 23;
a signal-receiving module 23 connected to plural similar sensing elements 4 (e.g. oil amount, temperature, liquid level and oil pressure) and receiving the control signal from the signal controlling module 22 for determining which sensing signal is simultaneously outputted to a signal-judging module 24 and a panel-indicating module 26;
a signal-judging module 24 for receiving the sensing signal from the signal receiving module 23 and then outputting a status signal to a displaying/alarming module 25 after judging if an abnormal situation reveals;
a displaying/alarming module 25 having double-color light emitting diodes (LEDs), whose number are corresponding to that of sensing sources and which change the display thereof depending on a selection of the sensing sources, and if the sensing signal is normal, the double-color LED reveals green color and if the sensing signal is abnormal, the double-color LED reveals red color for alarming the user; and
a panel-indicating module 26 for receiving the sensing signal from the signal receiving module 23 and driving a needle meter.

The present invention simultaneously inputs the sensing signals from several similar sensing elements 4 at different locations into the signal-receiving module 23, and then, through switching of the selecting switch 21 and the signal-controlling module 22 for selecting the sensing signal wanted to receive, this received sensing signal will simultaneously be outputted to the panel-indicating module 26 and the signal-judging module 24. The panel-indicting module 26 will directly display the value of this received sensing signal, and simultaneously the signal-judging module 24 will process a value comparison for abnormal ones. If it reveals abnormal, it can notice the user through the displaying/alarming module 25. The functional indicating meter 2 can be switched to display the value of each sensing element 4 located everywhere so as to achieve purposes of displaying and alarming.

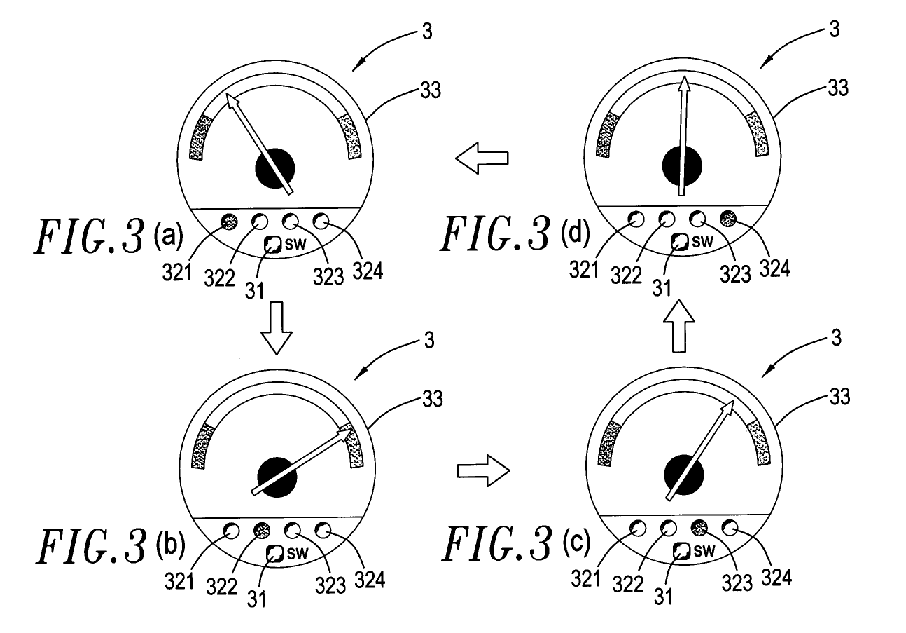

Please refer to FIGS. 3(a)˜3(d) which illustrate practicing schematic views of the functional indicating meter for cooperating with sensing elements in a preferable embodiment according to the present invention. As shown in FIGS. 3(a)˜3(d), the functional indicating meter 3 according to the present invention can cooperate with four similar sensing elements located at different positions (e.g. for oil amount, temperature, liquid level and oil pressure). Moreover, through the selecting switch 31 to cyclically switch the input signals for four sensing elements, the four double-color LEDs 321, 322, 323 and 324 can correspondingly display thereof, and the needle meter 33 at the upper portion will also simultaneously display the values thereof. Therefore, the user can easily acknowledge the status of different sensing elements at different locations only through one single functional indicating meter 3.

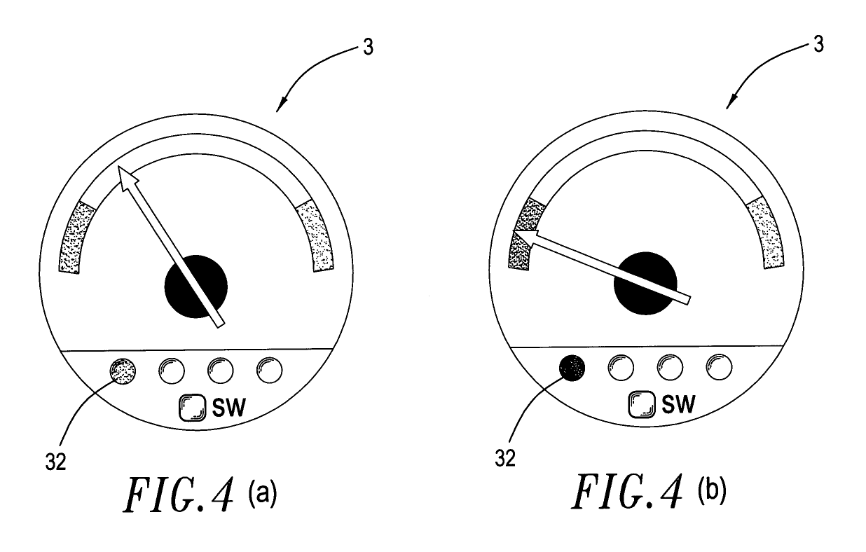

FIGS. 4(a) and 4(b) which illustrate practicing schematic views of the functional indicating meter for cooperating with sensing elements in another preferable embodiment according to the present invention. As shown in FIGS. 4(a) and 4(b), when the sensing signal inputted into the functional indicating meter 3 from the sensing element is normal, the double-color LEDs will reveal green color, and when the sensing signal is abnormal, the double-color LEDs will reveal red color for alarming the user. In addition, a buzzer or a horn also can be corporately used therewith to sound for noticing the user, beside through the displaying of the double-color LEDs.

The functional indicating meter for cooperating with sensing elements according to the present invention, when being compared with the other prior arts, further includes the advantages as follows:
1. The functional indicating meter for cooperating with sensing elements according to the present invention can be simply switched to display the value of each sensing element located everywhere so as to achieve the purposes of displaying and alarming and can timely provide the value and status of the sensing element for avoiding danger.
2. The functional indicating meter for cooperating with various sensing elements has advantages of small volume, easily install, easily use and low cost etc.
3. The functional indicating meter can cooperates with various sensing elements of measuring oil amount, temperature, liquid level and oil pressure etc.
4. The functional indicating meter for cooperating with sensing elements can be used in all kinds of traffic transportations, e.g. airplanes, boats and vehicles etc.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A functional indicating meter for cooperating with sensing elements, comprising:
a selecting switch for inputting a switching signal into a signal controlling module;
a signal-controlling module for outputting a control signal to a signal receiving module so as to control a sensing signal outputted by said signal receiving module;
a signal-receiving module connected to plural similar sensing elements and receiving said control signal from said signal controlling module for determining which sensing signal is simultaneously outputted to a signal-judging module and a panel-indicating module;
a signal-judging module for receiving said sensing signal from said signal receiving module and outputting a status signal to a displaying/alarming module after judging if an abnormal situation reveals;
a displaying/alarming module having double-color light emitting diodes (LEDs) which have a number corresponding to that of sensing sources and change displaying thereof depending on a selection of said sensing sources and if a sensing value is normal or not; and
a panel-indicating module for receiving said sensing signal from said signal receiving module and driving a needle meter,
wherein said functional indicating meter is simply switched to display said value of each sensing element located everywhere so as to achieve displaying and alarming.

2. The functional indicating meter for cooperating with according to claim 1, wherein each of said sensing elements is employed to sense one selected from a group consisting of an oil amount, a temperature, a liquid level and an oil pressure.

3. The functional indicating meter for cooperating with according to claim 1, wherein when said signal judging module detects an abnormal signal, said signal judging module further cooperates with a buzzer or a horn, except said double-color LED, to sound for warning the user.
